(19) United States
(12) Patent Application Publication
(10) Pub. No.: US 2025/0306399 A1
(43) Pub. Date: Oct. 2, 2025

(54) MYOPIA CORRECTIVE LENSES WITH A CONTINUOUS EFFECT DISTRIBUTION

(71) Applicant: Rodenstock GmbH, Muenchen (DE)

(72) Inventors: Stephan Trumm, Muenchen (DE); Wolfgang Becken, Neuried (DE); Anne Seidemann, Muenchen (DE)

(21) Appl. No.: 18/864,417

(22) PCT Filed: May 12, 2023
(86) PCT No.: PCT/EP2023/062714

§ 371 Date: Nov. 8, 2024

(30) Foreign Application Priority Data
May 12, 2022 (DE) 102022001664.8

(51) Int. Cl. G02C 7/04; G02B 5/18

(52) U.S. Cl. CPC G02C 7/044; G02B 5/1814; G02B 5/1866; G02B 2005/1804; G02C 2202/20; G02C 2202/24

(57) ABSTRACT

The present invention relates in particular to a spectacle lens which has at least one diffractive effect zone as at least a part of a viewing region of the spectacle lens such that the spectacle lens comprises diffractive microstructures in the diffractive effect zone, said microstructures generating at least one base effect in each view point of the diffractive effect zone or a myopia stopping effect which deviates therefrom, wherein the diffractive effect zone comprises a combination zone in which the diffractive microstructures generate a combination of the base effect and the myopia stopping effect simultaneously.

### TECHNICAL FIELD

The invention relates to a spectacle lens with a diffractive microstructure for the simultaneous generation of at least two different effects over at least a partial region of the spectacle lens in order to improve long-term wearing comfort.

### BACKGROUND

Particularly in the case of spectacle lenses for the correction of myopia, the often significant tendency for myopia to progress means that the wearing comfort of spectacle lenses once fitted, and therefore also the satisfaction of the spectacle wearer and the tolerance of the spectacles, decrease again after a short time.

In general, myopia is increasing dramatically worldwide, especially in Asia. The WHO estimates that over 50% of all people will be myopic by 2050. As an individual's myopia increases, the risk of associated eye diseases such as retinal detachment, glaucoma, cataracts and macular degeneration also increases dramatically. There is therefore great interest in slowing down the increase in myopia. There are several approaches to slowing down the progression of myopia with optical aids (vision aids). However, what all these approaches have in common is that they are very complex and costly and also quite inflexible when it comes to adapting to rapidly changing circumstances (e.g. changes in the prescription of spectacles, demands on the visual system).

To date, various optical effects relating to the tolerability and comfort of ophthalmic lenses, in particular spectacle lenses, have been investigated with regard to their influence on myopia and/or hyperopia and progression or development thereof depending on the optical and physiological mechanisms that are intended to explain or slow down progression or advancement, in particular deterioration. The existing approaches are substantially based on imaging the image in front of the retina, as this is intended to slow down the length growth of the eye. It has been shown that it is sufficient (or is even better) if this only occurs in the periphery of the retina.

One possible approach is the use of bifocal lenses and/or progressive lenses (PAL). On the one hand, by way of the addition, a region is imaged in front of the retina in the peripheral region when looking into the distance and, on the other hand, the image is not imaged behind the retina when looking up close, at least if accommodation is insufficient. This works better in children with accommodation insufficiency and/or convergence excess. However, with such approaches, acceptable results are only achieved in a smaller group with convergence excess. Bifocal lenses are cosmetically unacceptable, especially for children.

Another approach is based on special PALs (or radially symmetrical PALs) with a central focusing effect and a peripheral addition (e.g. DE 10 2009 053 467 A1).

PALs, as in these two approaches, have regions with large aberrations. If the spectacle lens power changes, which is often the case in children, a new, costly spectacle lens has to be produced, which is laborious. Furthermore, the quality of peripheral vision and also of foveal vision when looking through the periphery of the lenses is greatly reduced by the aberrations. If high demands are placed on the visual system (e.g. in road traffic), this can only be solved with a second pair of single vision spectacles. This further increases the effort and costs when changing the prescription. The acceptance of such solutions is therefore often low.

Other approaches are based on special contact lenses, for example. For example, progressive contact lenses with a higher plus effect in the periphery than in the central region have been investigated. However, as the contact lens moves on the eye, this also impairs foveal vision. In addition, a new lens has to be produced at great expense if the power is changed. Furthermore, handling and reliability are limited in the case of children. This is particularly true for young children, and the fact that the greatest effect is actually achieved if measures to slow down myopia are started at an early age makes things even more difficult.

Another approach with contact lenses utilises so-called Ortho-K contact lenses, which are worn overnight and deform the cornea. This is intended to correct the myopia centrally and also create a plus effect in the periphery (compared to centrally). However, each contact lens is also a special requirement here and a new lens must also be produced at great expense, e.g. in the case of a new prescription. Furthermore, the effects of corneal deformation on the metabolism and structure of the cornea are unclear, especially in young children.

The problem for spectacle wearers resulting from the progression of myopia is the steadily decreasing wearing comfort of spectacles once they have been fitted. One possible approach to myopia control is to use spectacle lenses with small additional lenses (so-called lenslets) with additional positive optical power. These additional lenses are formed from nub-shaped structures. The additional effect leads to a localised shift of the focal point in front of the retina and is therefore intended to counteract excessive length growth of the eye.

In the zone with the lenslets (hereinafter referred to as the “active zone”), the effect distribution is discontinuous: the imaging is blurred in the region of the lenslets and sharp in the region in between. When looking through the zone, these lenslets are irritating as they locally prevent sharp imaging. When the eye moves through this zone, further irritation occurs because the arrangement of the lenslets in front of the pupil changes depending on the direction of gaze.

### SUMMARY

The object of the present invention is therefore to improve the lasting compatibility of spectacles and thus to achieve long-term wearing comfort cost-effectively. According to the invention, this object is achieved by a spectacle lens having the features specified in the independent claims. Preferred embodiments are the subject of the dependent claims.

Thus, the invention provides a spectacle lens which has at least one diffractive effect zone as at least a part of a viewing region of the spectacle lens such that the spectacle lens comprises diffractive microstructures in the diffractive effect zone, said microstructures generating at least one base effect in each view point of the diffractive effect zone or a myopia stopping effect which deviates therefrom, wherein the diffractive effect zone comprises a combination zone in which the diffractive microstructures generate a combination of the base effect and the myopia stopping effect simultaneously.

The base effect is understood to be a dioptric effect in accordance with a spherical equivalent to compensate for a defective refraction of an eye of a spectacle wearer. The myopia stopping effect is a dioptric effect that deviates from the base effect. By realising the base effect and the myopia stopping effect by means of diffractive microstructures in the combination zone, it is now possible to realise local transitions in the intensity ratio (i.e. proportion of the base effect to the myopia stopping effect) without visible steps and apparent inhomogeneities in the transparency of the spectacle lens. For example, regions with a pure base effect (e.g. in the centre of a spectacle lens) can be quasi-continuously converted into (e.g. ring-shaped) regions in which the myopia stopping effect is additionally or predominantly generated without these regions having an apparently different transparency. This reduces irritation of the eye during eye movements, for example, compared to the use of refractive microlenses for the localised generation of additional focal regions.

The base effect or myopia stopping effect is understood to be the corresponding overall effect of the lens at the respective view point. This can also be influenced by a refractive effect of the lens body or its surface curvatures. For example, the diffractive microstructures of the spectacle lens can be formed on a first spectacle lens surface which has a base curve (curvature) which, together with a second, opposite spectacle lens surface, produces a refractive effect as a plus lens (converging lens) or minus lens (diffusing lens). However, the overall effect of the spectacle lens is then split by the diffractive microstructures into the base effect and the myopia stopping effect (with different focal lengths). The diffractive microstructures preferably produce a sharp imaging, at least for the base effect. For the myopia stopping effect, it is not absolutely necessary for a single sharp imaging (with a different focal length) to be produced. Several focal lengths in different diffraction orders could also be achieved.

Preferably, the myopia stopping effect has a shorter focal length than the base effect, particularly in each view point of the combination zone. The difference in the focal length is also referred to here as the additional effect (of the myopia stopping effect compared to the base effect). The additional effect is preferably in a range from about 1.5 dpt to about 5 dpt, in particular in a range from about 2 dpt to about 4 dpt. Insofar as the base effect leads to a sharp imaging on the retina, an imaging in front of the retina is achieved, especially when a shorter focal length is produced, which attenuates excessive length growth of the eye and thus efficiently leads to long-term wearing comfort for the spectacle lens. It is not absolutely necessary for the invention that the base effect and the myopia stopping effect are the same over the entire spectacle lens or even just over the diffractive effect zone. Rather, both the base effect and the myopia stopping effect could be different for different directions of vision, as is known, for example, for conventional progressive lenses. However, it is particularly preferable if at least the additional effect (i.e. the difference between the focal lengths of the base effect and the myopia stopping effect) remains substantially constant in the combination zone, i.e. does not differ significantly for different view points within the combination zone, in particular by no more than about 2 dpt, preferably no more than about 1 dpt. In other words, when the base effect is changed across the spectacle lens (in particular across the combination zone), the myopia stopping effect is preferably also carried along.

Where reference is made here to the simultaneous generation of a base effect and a myopia stopping effect (in the combination zone), this is intended to express the fact that the diffractive microstructures in an environment which represents the cross section of an object-point-related light beam through the pupil of a spectacle wearer generate both effects (base effect and myopia stopping effect) simultaneously by interacting around a corresponding view point. This environment can preferably be considered to be a circular disc with a diameter in the range from about 1.5 mm to about 8 mm, preferably in a range from about 3 mm to about 6 mm, even more preferably in a range of no more than about 5 mm or even no more than about 4 mm, or even no more than about 3 mm.

The consideration of such an environment around the respective view point is interesting insofar as the diffractive effect results as an interference of wave fronts with a finite lateral extent, wherein the geometry (e.g. periodicity, amplitude or step/jump height, glaze angle, etc.) of the diffractive microstructures varies over this environment. This can be the case in particular if the base effect and the myopia stopping effect are generated by spatially separated diffractive substructures within the combination zone, i.e. the base effect is generated by one of the substructures and the myopia stopping effect by another of the substructures. In this case, however, the two substructures are so close together (especially alternating with each other) that the observed environment around each view point of the combination zone always contains both substructures. As a result, the base effect and the myopia stopping effect are not perceived by the eye as spatially separated from each other. For this characterisation of the diffractive microstructures (in particular such substructures) and their optical effect for a respective view point (in particular within the combination zone), it is particularly possible to consider a circular environment around the view point, which has a diameter of no more than 3 mm, or even no more than 2 mm or even no more than 1 mm.

Preferably, the diffractive microstructures are formed in a ring-shape around a centre of the spectacle lens. It is particularly preferable for the diffractive microstructures to be rotationally symmetrical.

Preferably, the diffractive microstructures have a sawtooth shape in a cross section. Preferably, the diffractive microstructures have constant step heights. However, the radial spacing of the steps is preferably dependent on the distance from the centre and, in particular, decreases substantially inversely proportionally to the distance from the centre.

In a preferred embodiment, the base effect and the myopia stopping effect are each brought about by a corresponding diffraction order of the light diffraction by the diffractive microstructures. In a particularly preferred embodiment, the base effect and/or the myopia stopping effect is produced as the zeroth diffraction order of the diffractive microstructures.

In a preferred embodiment, the diffractive microstructures for each view point (of a plurality of view points) within the combination zone have at least substantially a single periodicity, wherein the base effect and the myopia stopping effect are brought about by different diffraction orders of the (single) diffraction grating formed thereby. The respective diffraction orders of the base effect and the myopia stopping effect differ from each other, particularly preferably by 1.

In a preferred embodiment, the diffractive microstructures comprise, for each view point, a plurality of view points within the combination zone:
at least one first diffractive substructure which substantially generates the base effect; and
at least one second diffractive substructure, which substantially generates the myopia stopping effect.

Particularly preferably, the at least one first substructure is formed by a first periodic diffraction grating with a first grating period and a first grating amplitude, while the at least one second substructure is formed by a second periodic diffraction grating with a second grating period and a second grating amplitude. The term “grating amplitude” here does not refer to the influence of a conventional amplitude grating on the local attenuation of a light wave. Rather, the local influence on the light wave is generally meant. This can indeed be an attenuation of the light wave by a conventional amplitude grating. In the context of the present invention, however, it is preferable to utilise phase gratings by means of a refractive index transition. In particular for the preferred case of a phase grating (due to refractive index transitions), the “grating amplitude” meant here describes the spatially variable (in particular periodic) influence on the optical path length, e.g. the local layer thickness of a layer forming the diffractive microstructures with a refractive index that differs from the refractive index of the main body of the spectacle lens. For example, in the case of sawtooth-shaped microstructures, the grating amplitude can be described by the step height of the sawtooth-shaped cross section of the microstructures.

In a particularly preferred embodiment, the first grating amplitude and the second grating amplitude differ from each other, while preferably the first and second grating periods substantially coincide. In this case, “substantially” means in particular that deviations from an exact match should be possible, which in particular realise a global radial variation of grating periods over the entire spectacle lens.

In this embodiment, in the case of (substantially) identical grating periods, the two substructures correspond to a certain extent in their diffraction factors. However, they differ from each other in their form factors. This will be explained in greater detail later. Due to the different grating amplitudes (form factors), different diffraction orders of the respective substructure can be specifically selected, which provide the base effect and the myopia stopping effect.

In a further preferred embodiment, the first grating period and the second grating period differ from each other, while preferably the first and second grating amplitudes substantially coincide. This embodiment provides a particularly high degree of flexibility, since both the absolute value of the base effect and the myopia stopping effect as well as their relative position, i.e. the additional effect, can be set relatively freely (in particular steplessly) via the continuously selectable grating periods. In particular, there is no restriction to the specific selection of diffraction orders (i.e. in steps).

In principle, it is also possible for both the grating amplitudes and the grating periods of the two substructures to differ from each other, which can again provide a greater degree of freedom for selecting/adapting the base and myopia stopping effect.

Preferably, the diffractive microstructures comprise a plurality of first substructures and a plurality of second substructures, in each case arranged alternately with respect to each other. In other words, at least within the combination zone there is usually a second substructure between two first substructures and vice versa.

In particular when using a plurality of alternately arranged first and second substructures, it is particularly preferable if, along a continuous path (in particular running radially on the lens) within the combination zone, a number of the first grating periods of the first substructures and a number of the second grating periods of the second substructures change successively in opposite directions. In other words, along a continuous path that alternately crosses first and second substructures, one number of grating periods increases while the other number of grating periods decreases along the same path. This means that the respective region of one type of substructure increases (quasi-)continuously along the path, while the respective region of the other type of substructure decreases (quasi-)continuously. This results in a (quasi-)continuous change in the proportion of the base effect relative to the proportion of the myopia stopping effect, wherein the eye does not perceive any (step-like) inhomogeneity of the glass.

Preferably, a number of grating periods in each substructure is in the range of about 2 to about 200, preferably in a range of at least about 5, more preferably at least about 10; and/or in a range of not more than about 100.

### BRIEF DESCRIPTION OF THE DRAWINGS

In the following, the invention is further described with reference to the accompanying drawings by means of preferred embodiments. The drawings show:

FIG. 1A to 1D schematic cross sections through exemplary spectacle lenses to illustrate the diffractive gratings formed by the diffractive microstructures;

FIG. 2 a schematic illustration for determining the phase difference for two neighbouring beams on an arbitrary, not necessarily periodic surface;

FIG. 3 a prism with back surface grating with blaze angle to visualise locally periodic microstructures;

FIG. 4 a prism with complex structured grating: the portion within a period is divided into different subportions, which can represent substructures;

FIG. 5 distributions of diffraction factor, form factor, and total intensity as a function of the angle of emergence φ′ for the blaze angle β=3.8°;

FIG. 6 course of the intensity in the orders 0 and −1 as well as in the sum of the remaining orders as a function of the blaze angle;

FIG. 7A to 7D schematic cross sections of preferred diffractive microstructures based on several substructures;

FIG. 8 distributions of diffraction factor, form factor, and total intensity as a function of the angle of emergence φ′ for another example of a diffractive microstructure;

FIG. 9 the intensity distributions on different orders as a function of the number of grating periods per substructure;

FIGS. 10A and 10B examples of particularly simple microstructures.

### DETAILED DESCRIPTION

The present invention thus provides spectacle lenses in which, in an active zone (diffractive effect zone or combination zone), at least part of the light enables a sharp imaging on the retina of the spectacle wearer, while another part of the light is focused in such a way that a stimulus is provided against the myopia-causing increase in eye length. In contrast to conventional spectacle lenses, a spectacle lens according to the invention also provides a substantially homogeneous image in the active zone. In particular, a continuous visual impression is created when the pupil moves.

In general, the active zone, i.e. the diffractive effect zone and/or the combination zone, is not limited to certain areas on the lens. In principle, the diffractive effect can be used anywhere on the lens. Particularly preferably, however, the combination zone leaves out at least one central viewing region of the spectacle lens (e.g. with a diameter of about 10 mm or even about 15 mm). Further preferably, the combination zone fills an annular region between a radius of about 20 mm and about 35 mm or even between a radius of about 20 mm and about 40 mm, or even between a radius of about 15 mm and about 50 mm.

With a spectacle lens according to the invention, it is achieved in particular that part of the light is focused on the retina with a first effect (base effect, S_{G}) and another part of the light is focused in front of the retina with a second effect (myopia stopping effect, S_{M}), which is more positive than the base effect by a third effect (additional effect ΔS).

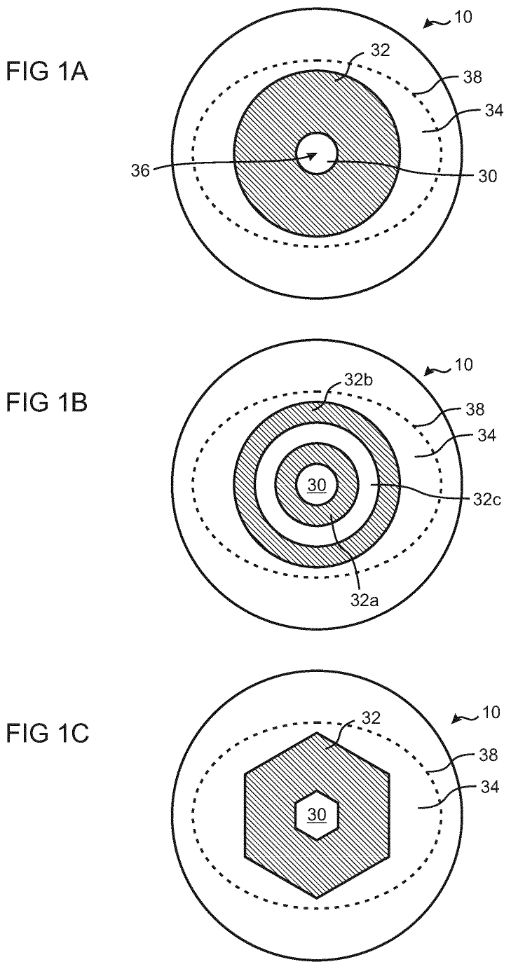

A fourth effect (effect of the base glass S_{K}) contributes to both the base effect and the myopia stopping effect. This effect can also be zero or change over the region of the glass. Special diffractive microstructures also contribute to the myopia stopping effect and/or the base effect. At least the splitting into the base effect and the myopia stopping effect is brought about by the diffractive microstructures. FIG. 1A to 1D, which will be described in greater detail later, schematically illustrate examples of a possible structure of the spectacle lens comprising a base lens and the diffractive microstructure. Both can preferably be integrally formed from the same material. Nevertheless, the macroscopic curvature of the base lens with its refractive effect can be distinguished from the microstructures with their diffractive effect, at least as a model.

As described in greater detail below, the preferred axial extent of the diffractive microstructures depends on the diffraction orders used. In particular, it is determined as the product of the diffraction order and the design wavelength divided by the difference in the refractive indices of the two media. In preferred embodiments, the first diffraction order is used. The lateral dimensions of corresponding diffraction gratings are typically in the range from about 1 mm to about 0.01 mm. However, more specific details for special embodiments will also be explained later.

The lateral extent of the individual grating elements (periods) of the diffraction grating results from the design of the structure. For simple gratings, the principle is that the lateral extent is linear-reciprocal to the prismatic effect of the glass at this point. For a given sphero-cylindrical effect, this must increase from the centre to the edge of the glass according to the Prentice formula Prism=Effect*Radius. The extent is therefore particularly reciprocal to the radius. The Prentice formula also shows that the prismatic effect increases with the desired sphero-cylindrical effect. This results in a wide range of lateral extents for the individual grating elements. This will also be explained later. The variation in the order of magnitude can be clearly explained by the fact that, for example, in the case of a diffractive lens with an effect of around 10 dpt, the order of magnitude of the grating constants in the region of the lens centre is in the region of 1 mm and in the periphery via the 1/r law is typically 1/30 of this, i.e. 0.03 mm or slightly less.

The diffractive grating (i.e. the diffractive microstructures) can act against air, as illustrated in FIG. 1A to 1D. Nevertheless, thin layers that do not significantly change the structure can be applied, e.g. as a hard layer, anti-reflective layer or topcoat. In a preferred embodiment, the structure is covered by a cover layer which is thicker than the structure height and preferably provides a flat surface. The refractive index of this layer must then be taken into account in the effect of the structure.

In a preferred embodiment, the diffractive structure is created rotationally symmetrically around the centre or the main view point or the far point of the lens. This avoids unwanted prismatic effects and the design of the lens can be defined particularly easily around the corresponding point.

In a further preferred embodiment, the periodicity or the course of the grating is rotationally symmetrical around the centre, but not necessarily the structure height. This allows, for example, structures in which the intensity distribution depends on the polar angle.

The base effect is represented by the effect of the base glass and the effect S_{diff,G} of the m_{G}-th diffraction order of the diffractive structure of the diffraction grating. The myopia stopping effect results from the effect of the base glass and the (at least one) effect S_{diff,M} of the (at least one) m_{M}-th order. The difference between the effect of the m_{G}-th and the m_{M}-th diffraction order(s) is therefore the additional effect ΔS.

The proportion of the incident radiation that goes into the base effect (the m_{G}-th diffraction order) and the proportion of the incident radiation that goes into the (at least one) myopia stopping effect (m_{M}-th diffraction order) is determined by the structure (e.g. height) of the diffractive grating. This can be determined in such a way that a desired intensity distribution is realised. This is explained in greater detail below.

Part of the incident radiation can also be diffracted into other orders. This can be undesirable and can be minimised as far as possible. This can be achieved in particular by selecting the appropriate structure height (or amplitude or step height) of the diffractive microstructure, as explained in greater detail below.

As an alternative to just a single m_{M}-th diffraction order, the myopia stopping effect can also be formed from several diffraction orders. This is possible because its primary purpose is to provide an incentive against further length growth of the eye and not to produce a sharp imaging.

In a preferred case, the orders of base effect m_{G} and myopia stopping effect mm are directly adjacent to each other (m_{M}=m_{G}±1). In this case, the grating can assume a sawtooth shape and the intensity distribution can be controlled by the height of the respective spikes. In the simplest case, m_{G}=0 and consequently m_{M}=±1. The base effect is therefore not influenced by the diffractive structure and corresponds to the effect of the base glass. The diffractive structure therefore provides the additional effect. However, other m_{G} can also be selected. This allows the effect of the base lens to be reduced while maintaining the same base effect, thereby reducing the curvature of the surfaces and ultimately the thickness of the lens. Furthermore, the colour error for the base effect can be reduced by a clever choice of the effect of the base lens and the effect of the m_{G}-th order grating.

As a first approximation, the dioptric effect S_{diff} of the diffractive grating for a given grating parameter A is linearly dependent for the wavelength λ on the diffraction order m:

$${S}_{diff} ( m ) = \frac{m λ}{A} \qquad ( E1 )$$

The grating parameter A describes the periodicity of the grating as a function of the distance from the centre. Details on the structure of the grating and the definition of the grating parameter are discussed in greater detail below.

While it is advantageous to minimise (or at least not increase) the colour error for the imaging due to the base effect, a (larger) colour error can be accepted for the imaging due to the myopia stopping effect, as there is no sharp imaging on the retina anyway. The distribution of the overall effect between the refractive component (effect of the base lens) and the diffractive component required to fully compensate for the colour error depends on the refractive indices of the materials of the lens body n_{K} and any cover layer n_{S} as well as the Abbe number v_{K} of the lens body material. Details on this, including the definition of the colour error parameter G as a function of the material parameters, are discussed in greater detail below.

The colour error does not necessarily have to be fully compensated. It is sufficient if the colour error is partially compensated or partially overcompensated, i.e. a smaller colour error (in the normal or abnormal direction) remains than a purely refractive lens would have.

An improvement can already be achieved if

$$\frac{{m}_{G}}{Δ m} \frac{Δ S}{{S}_{G}} < 2 \cdot {σ}_{0} ( {n}_{K} , {v}_{K} ) \qquad ( E2 )$$

wherein σ₀ is a constant dependent on the Abbe number and the refractive index, as will be explained later. With the usual materials σ₀ is in the region of 0.09.

Some examples are summarised in Table 1.

TABLE 1
Examples of effects and diffraction orders with m_{M} = m_{G} ± 1

| S_{G} | S_{M} | ΔS | S_{K} | S_{diff, G} | | S_{diff, M} | | |
|---|---|---|---|---|---|---|---|---|
| [dpt] | [dpt] | [dpt] | [dpt] | [dpt] (m_{G}) | | [dpt] (m_{M}) | | Note |
| +2.0 | +5.0 | +3.0 | +2.0 | 0.0 | (0) | +3.0 | (1) | Simplest case |
| | | | | | | | | plus glass |
| −2.0 | +1.5 | +3.5 | −2.0 | 0.0 | (0) | +3.5 | (1) | Simplest case |
| | | | | | | | | minus glass |
| +10.0 | +11.5 | +1.5 | +8.5 | +1.5 | (1) | +3.0 | (2) | Colour error |
| | | | | | | | | compensation |
| | | | | | | | | plus glass |
| −10.0 | −8.5 | +1.5 | −8.5 | −1.5 | (1) | 0.0 | (0) | Colour error |
| | | | | | | | | compensation |
| | | | | | | | | minus glass |
| +5.0 | +7.5 | +2.5 | 0.0 | +5.0 | (2) | +7.5 | (3) | Thinnest glass |
| | | | | | | | | without base |
| | | | | | | | | effect |

As also described below, small portions of the incident light can also reach neighbouring diffraction orders (mainly the directly neighbouring diffraction orders m_{M}−1 and m_{M}+2 or m_{M}−2 and m_{M}+1). However, as long as the structure is of sufficient quality and the diffraction into unwanted orders is not too high, this is acceptable and does not hinder the application. Preferably, the proportion of diffraction into unwanted orders in regions in which full correction is to be achieved (in particular in central viewing regions and/or in far vision regions and/or in near vision regions, i.e. in mainly used viewing regions of the lens) is not greater than about 5%, even more preferably not greater than about 3%, most preferably not greater than about 1%. In other regions, a proportion of 20% or more in unwanted orders could still be tolerable. There are cases in which the proportion of foreign orders cannot be reduced any further. If, for example, two neighbouring orders are to have the same intensity, then there is a theoretical minimum of just over 20% of the energy that ends up unintentionally in other orders. However, there is not a sharp theoretical limit for every situation.

The use of neighbouring diffraction orders of a sawtooth structure avoids unnecessary complexity and allows sufficient flexibility for most applications. All desired additional effects can be realised by selecting the grating parameter A. However, there is a certain dependency between the base effect and the additional effect, since according to equation (E1)

$${S}_{diff , M} = \frac{{m}_{M}}{{m}_{G}} \cdot {S}_{diff , G} = \frac{{m}_{G} \pm 1}{{m}_{G}} \cdot {S}_{diff , G} \qquad ( E3 )$$

In many cases, however, the leeway is sufficient because, for example, colour error correction is more relevant for high effects than for low effects.

For some applications, it can be useful to increase the flexibility in setting the effects by not restricting them to neighbouring diffraction orders. This allows effect distributions with arbitrary integer ratios.

$${S}_{diff , M} = \frac{{m}_{M}}{{m}_{G}} \cdot {S}_{diff , G} \qquad ( E4 )$$

This enables, for example, colour error correction for lower base effects or higher additional effects as well as better adjustment to the colour error of the base glass. Furthermore, the additional effect can be fine-tuned if the base effect is to be generated only or predominantly by the grating.

Some examples are summarised in Table 2.

TABLE 2
Examples of effects and diffraction orders with m_{M} ≠ m_{G} ±
1. Compared to the situation in Table 1, the colour error compensation
is almost complete here and the additional effect is significantly higher.

| S_{G} | S_{M} | ΔS | S_{K} | S_{diff, G} | | S_{diff, M} | | |
|---|---|---|---|---|---|---|---|---|
| [dpt] | [dpt] | [dpt] | [dpt] | [dpt] (m_{G}) | | [dpt] (m_{M}) | | Note |
| +5.0 | +8.5 | +3.5 | +4.5 | +0.5 | (1) | +4.0 | (8) | Colour error |
| | | | | | | | | compensation |
| | | | | | | | | plus glass |
| −10.0 | −6.5 | +3.5 | −9.0 | −1.0 | (−2) | +2.5 | (5) | Colour error |
| | | | | | | | | compensation |
| | | | | | | | | minus glass |
| +4.5 | +8.0 | +3.5 | 0.0 | +4.5 | (9) | +8.0 | (16) | Thinnest glass |
| | | | | | | | | without base |
| | | | | | | | | effect |

Secondary maxima can also occur in the intensity distribution. For the base effect, the aim should be to use only one maximum (or closely neighbouring secondary maxima) in order to ensure a sharp imaging. For the myopia stopping effect, on the other hand, several maxima (especially secondary maxima) with a greater distance between them can also be used, as a sharp imaging is less important here.

Overall, the influencing factors on the design of diffractive microstructures are better understood by the following basic explanations.

For example, US 2013/0229619 A1 (and US 2013/0235337 A1) describes the optical properties of a surface (in particular an at least locally flat surface) that according to the equation

$${z}_{D} ( x + d ) = {z}_{D} ( x ) , 0 \leq x \leq Nd \qquad ( 1 )$$

has a periodic arrow height z_{D}(x). If a parallel light beam (flat wavefront) is incident on such a surface at any angle, covering the entire width 0≤x≤Nd, then the incident light has an angular distribution of intensity I=I_{F}×I_{D} which can be summarised as the product of a diffraction factor I_{D} and a form factor IF. The diffraction factor (apart from the angle of incidence) only depends on the period d and the number of periods N. The form factor, on the other hand, is independent of N but depends on the shape of the function z_{D}(x) within a period.

The background to the use of diffractive structures in US 2013/0229619 A1 is the possibility of colour fringe correction. In contrast, it is now proposed to use diffractive gratings to improve the long-term wearing comfort of spectacle lenses by suppressing myopia progression. The desired optical properties are that, in addition to a base effect, a lens produces a second image that is created in front of the retina, typically with an additional effect of around +3 dpt in particular. Overall, this additional effect is preferably in a range of around +1.5 dpt to around +5 dpt.

To illustrate the principle, the prism or flat surface with an equidistant grating will be considered below for simplicity. This already provides a very good local description (i.e. for a specific view point and its local surroundings). The results can then be transferred to lenses analogously to the method in US 2013/0229619 A1. The following explains how the intensity distribution changes if more complex structures are permitted within a grating period, such as different grating constants and different blaze angles in substructures.

For a better overview, the initial situation from US 2013/0229619 A1 with regard to equidistant gratings is summarised again here with slightly different nomenclature. A situation of a finite equidistant grating with N periods is assumed, wherein the grating profile may initially be arbitrary. The normal of the surface on which the grating is applied points in the z direction, and the grating is defined by the profile z_{D}(x), 0≤x≤x₀=Nd from equation (1).

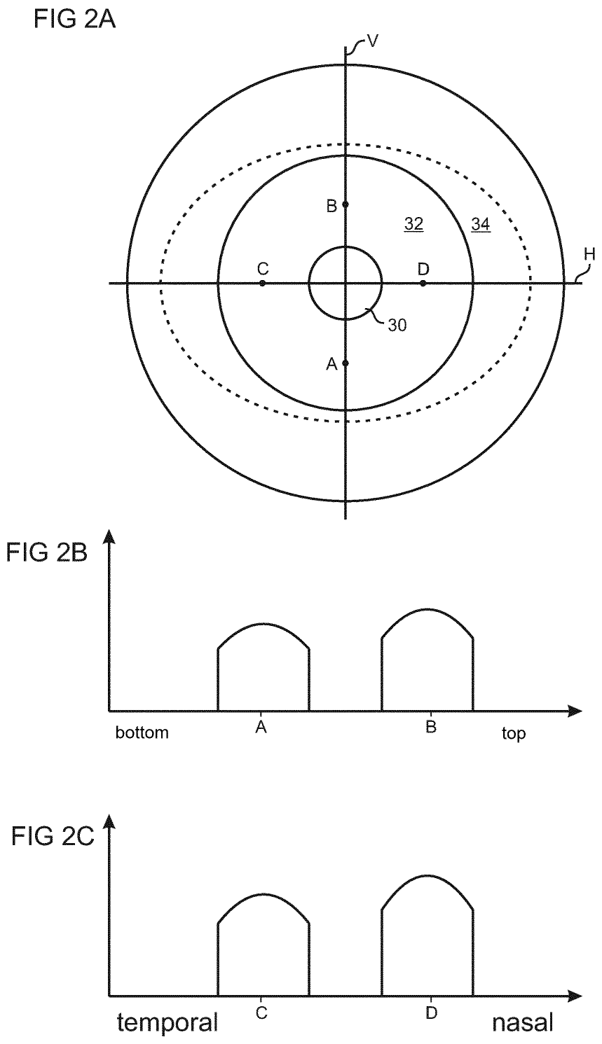

If light (coherent over the entire width of the grating) is incident on the grating at the angle of incidence ϕ against the surface normal, then it makes sense to first determine the occurring phase shift as a function of x. As can be seen from FIG. 2, two neighbouring beams enter into a phase relationship even with an arbitrary, not necessarily periodic grating. If the penetration points are given by

$${P}_{1} = ( \begin{matrix}{x}_{1} \\ {z}_{D} ( {x}_{1} )\end{matrix} ) , {P}_{2} = ( \begin{matrix}{x}_{2} \\ {z}_{D} ( {x}_{2} )\end{matrix} ) \qquad ( 2 )$$

then the projection portions λ₁, λ₂ can be calculated by

$$( ( {P}_{1} + {λ}_{1} {N}^{′} ) - {P}_{2} ) {N}^{′} = 0 \qquad ( 3 )$$

$$\begin{matrix}{λ}_{1} = ( {P}_{2} - {P}_{1} ) {N}^{′} \\ = ( {x}_{2} - {x}_{1} ) sin {φ}^{′} + ( {z}_{D} ( {x}_{2} ) - {z}_{D} ( {x}_{1} ) ) cos {φ}^{′}\end{matrix} \qquad ( 4 )$$

$$\begin{matrix}{λ}_{2} = ( {P}_{1} - {P}_{2} ) N \\ = ( {x}_{1} - {x}_{2} ) sin φ + ( {z}_{D} ( {x}_{1} ) - {z}_{D} ( {x}_{2} ) ) cos φ\end{matrix} \qquad ( 5 )$$

The phase difference of beam 2 compared to beam 1 is now

$$\begin{matrix}{Φ}_{21} = {n}^{′} {λ}_{1} + n {λ}_{2} \\ = ( {x}_{2} - {x}_{1} ) ( {n}^{′} sin {φ}^{′} - n sin φ ) + ( {z}_{D} ( {x}_{2} ) - {z}_{D} ( {x}_{1} ) ) ( {n}^{′} cos {φ}^{′} - n cos φ ) \\ = ( {x}_{2} - {x}_{1} ) {p}_{s} + ( {z}_{D} ( {x}_{2} ) - {z}_{D} ( {x}_{1} ) ) {p}_{c}\end{matrix} \qquad ( 6 )$$

with the abbreviations

$${p}_{s} ( ϕ , {ϕ}^{′} ) = ( {n}^{′} sin {ϕ}^{′} - n sin ϕ ) ; {p}_{c} ( ϕ , {ϕ}^{′} ) = ( {n}^{′} cos {ϕ}^{′} - n cos ϕ ) \qquad ( 7 )$$

If the refractive surface is actually flat, i.e. z_{D}(x)=0 then the second term is omitted, and the law of refraction would result from the first term by the requirement of vanishing phase difference for all x.

The phase of any beam, defined as the phase difference with respect to the beam at x=0 is, under the assumption z_{D}(0)=0:

$$Φ ( ϕ , {ϕ}^{′} , x ) = x ( {n}^{′} sin {ϕ}^{′} - n sin ϕ ) + {z}_{D} ( x ) ( {n}^{′} cos {ϕ}^{′} - n cos ϕ ) \qquad ( 8 )$$

Conveniently, the phase can also be introduced as the function

$$Φ ( {p}_{s} , {p}_{c} , x ) = {xp}_{s} + {z}_{D} ( x ) {p}_{c} \qquad ( 9 )$$

The amplitude in the direction of emergence ϕ′ is

$$U ( {y}_{s} , {p}_{c} ) = A {\int }_{0}^{{x}_{0}} Exp ( ik Φ ( {p}_{s} , {p}_{c} , x ) ) dx \qquad ( 10 )$$

with k=2π/λ (dimensional factors were neglected here that should take into account the fact that different angled points on the grating are hit by different “numbers” of beams per unit area).

If now k=2π/λ and the periodicity condition from Eq. (1) holds, then Eq. (10) can be rewritten as

$$\begin{matrix}U ( \text{?} ) = A \text{?} Exp ( ik Φ ( \text{?} ) ) d \text{?} + A \text{?} Exp ( ik Φ ( \text{?} ) ) d \text{?} + … \\ = A \text{?} Exp ( ik Φ ( \text{?} ) ) d \text{?} + A \text{?} Exp ( ik Φ ( \text{?} + d ) ) d \text{?} + … \\ = A \text{?} Exp ( ik Φ ( \text{?} ) ) d \text{?} + Exp ( ikd \text{?} ) A \text{?} Exp ( ik Φ ( \text{?} ) ) d \text{?} + … \\ = A \text{?} Exp ( ik Φ ( \text{?} ) ) d \text{?} [ 1 + Exp ( ikd \text{?} ) + Exp ( 2 ikd \text{?} ) + … + \\ Exp ( ( N - 1 \text{?} ikd \text{?} ) ] \\ = A \text{?} Exp ( ik Φ ( \text{?} ) ) d \text{?} \frac{1 - Exp ( Nikd \text{?} )}{1 - Exp ( ikd \text{?} )} \\ = \text{?}\end{matrix} \qquad ( 11 )$$

$$\text{?} \text{indicates text missing or illegible when filed}$$

wherein the periodicity was utilised after the substitution. The front factor is a form factor U_{F}(d,pₛ,p_{c}) and the rear factor U_{D}(N,d,pₛ) takes into account the periodicity of the diffractive grating, i.e. it is a diffraction factor.

The intensity distribution is thus given by

$$\begin{matrix}I ( {p}_{s} , {p}_{c} , N , d ) = {\vert U ( {p}_{s} , {p}_{c} , N , d ) \vert}^{2} \\ = {\vert {U}_{F} ( {p}_{s} , {p}_{c} , d ) \vert}^{2} {\vert {U}_{D} ( {p}_{s} , N , d ) \vert}^{2} \\ = : {{I}_{F} ( {p}_{s} , {p}_{c} , d )}^{′} {I}_{D} ( {p}_{s} , N , d )\end{matrix} \qquad ( 12 )$$

For practical reasons, new designations are now introduced for the argument:

$$kd = \frac{2 π}{λ} d : = 2 π κ \qquad ( 13 )$$

The diffraction factor can then be rewritten as

$$\begin{matrix}\begin{matrix}{U}_{D} ( {p}_{s} , N , d ) = \frac{Exp ( {Nikdp}_{s} / 2 ) Exp ( - {Nikdp}_{s} / 2 ) - Exp ( {Nikdp}_{s} / 2 )}{Exp ( {ikdp}_{s} / 2 ) Exp ( - {ikdp}_{s} / 2 ) - Exp ( {ikdp}_{s} / 2 )} \\ = Exp ( ( N - 1 ) {ikdp}_{s} / 2 ) \frac{sin ( {Nkdp}_{s} / 2 )}{sin ( {kdp}_{s} / 2 )}\end{matrix} \\ {U}_{D} ( {p}_{s} , N , k ) = Exp ( ( N - 1 ) pik {p}_{s} ) \frac{sin ( Npk {p}_{s} )}{sin ( p k {p}_{s} )} and & ( 14 ) \\ {I}_{D} ( {p}_{s} , N , d ) = {( \frac{sin ( \frac{Nkd {p}_{s}}{2} )}{sin ( \frac{kd {p}_{s}}{2} )} )}^{2} \\ {I}_{D} ( {p}_{s} , N , κ ) = {( \frac{sin ( N π κ {p}_{s} )}{sin ( πκ {p}_{s} )} )}^{2} & ( 15 )\end{matrix}$$

The function sin(Nx)/sin x is known to have sharp maxima where x=πm, m∈Z. This means that maxima occur where

$$πκ {p}_{s} = λ m , m ∈ ℤ \\ {p}_{s} = \frac{m}{κ} \\ {n}^{′} sin {ϕ}^{′} - n sin ϕ = \frac{m λ}{d} \qquad ( 16 )$$

This is the well-known diffractive extension of the law of refraction.

The form factor is given by

$$\begin{matrix}{U}_{F} ( {p}_{s} , {p}_{c} , d ) = A {\int }_{0}^{d} Exp ( ik Φ ( {p}_{x} , {p}_{c} , x ) ) dx \\ = A {\int }_{0}^{d} Exp ( ik ( {xp}_{s} + {z}_{D} ( x ) {p}_{c} ) ) dx\end{matrix} \qquad ( 17 )$$

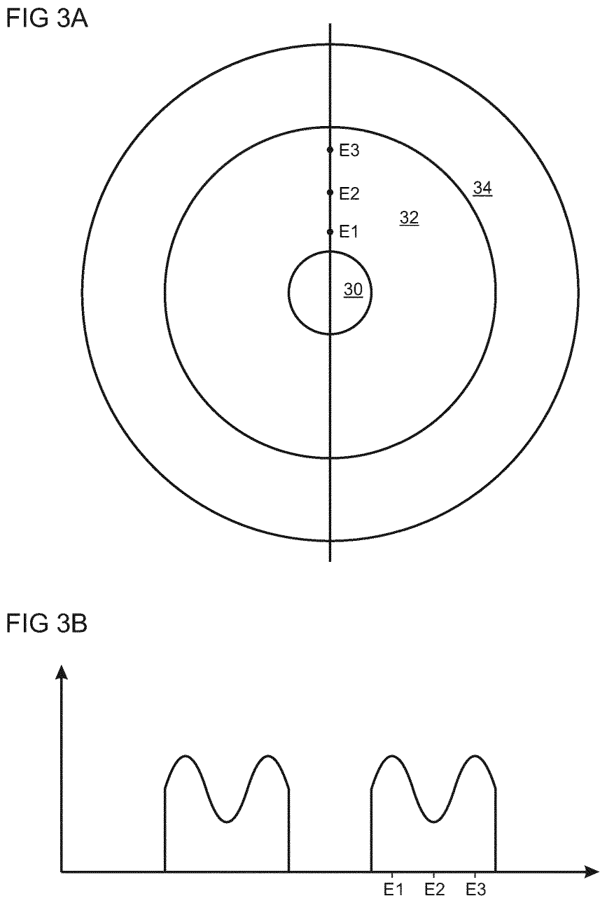

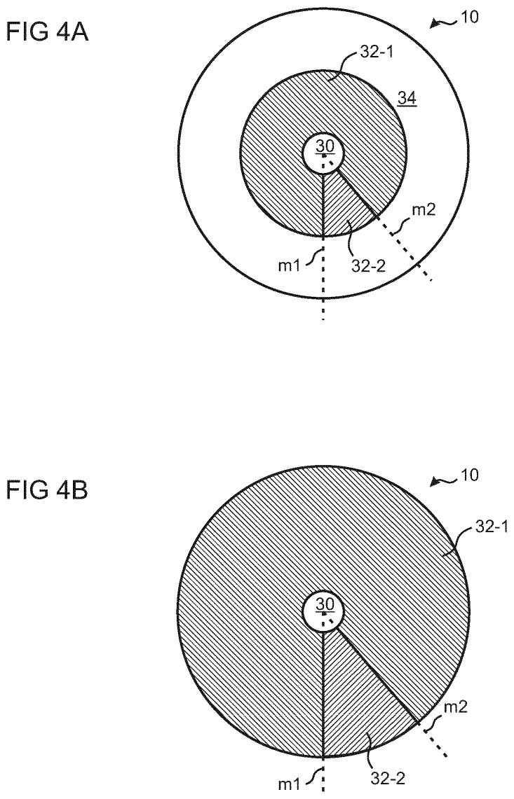

and cannot be further simplified without further assumptions. For the special case of a sawtooth grating, however, the following applies

$${z}_{D} ( x ) = - x tan β , 0 \leq x \leq d \qquad ( 18 )$$

wherein β is the so-called blazing angle. Its sign is initially arbitrary, and is chosen in the following so that β>0 describes the case where a back surface grating on a prism with base at the bottom (see FIG. 3) enlarges the prism. Thus,

$$\begin{matrix}{U}_{F} ( {p}_{s} , {p}_{c} , d , β ) = A {\int }_{0}^{d} Exp ( ik ( {xp}_{s} - {xp}_{c} tan β ) ) dx \\ = A {\int }_{0}^{d} Exp ( ikxq ) dx \\ = {\frac{A}{ikq} [ Exp ( ikxq ) ]}_{0}^{d} \\ = \frac{A}{ikq} [ Exp ( ikdq ) - 1 ]\end{matrix} \qquad ( 19 )$$

wherein β was included as an additional argument.

The factor

$$q : = ( {p}_{s} - {p}_{c} tan β ) \qquad ( 20 )$$

has a very descriptive meaning, namely

$$\begin{matrix}\begin{matrix}q = ( {p}_{s} - {p}_{c} tan β ) = \frac{1}{cos β} ( {p}_{x} cos β - {p}_{c} sin β ) \\ = \frac{1}{cos β} ( ( {n}^{′} sin {ϕ}^{′} - n sin ϕ ) cos β - ( {n}^{′} cos {ϕ}^{′} - n cos ϕ ) sin β ) \\ = \frac{1}{cos β} ( {n}^{′} ( sin {ϕ}^{′} cos β - cos {ϕ}^{′} sin β ) - n ( sin ϕ cos β - cos ϕ sin β ) ) \\ = \frac{1}{cos β} ( {n}^{′} sin ( {ϕ}^{′} - β ) - n sin ( ϕ - β ) ) \\ = \frac{1}{cos β} {p}_{s} ( ϕ - β , {ϕ}^{′} - β ) = : \frac{1}{cos β} {p}_{x , i}\end{matrix} \\ This gives & ( 21 ) \\ \begin{matrix}{U}_{F} ( {p}_{s} , {p}_{c} , d , β ) = \frac{A}{ikq} [ Exp ( ikdq ) - 1 ] \\ = \frac{2 A}{kq} Exp ( ikdq / 2 ) [ \frac{Exp ( ikdq / 2 ) - Exp ( - ikdq / 2 )}{2 i} ] \\ = \frac{2 A}{kq} Exp ( ikdq / 2 ) sin ( kdq / 2 ) \\ = Ad Exp ( ikdq / 2 ) \frac{sin ( kdq / 2 )}{kdq / 2} \\ = Ad Exp ( ikdq / 2 ) sin c ( kdq / 2 ) \\ = Ad Exp ( {ikdp}_{s β} / ( 2 cos β ) ) sin c ( {kdp}_{s β} / ( 2 cos β ) ) \\ {U}_{F} ( {p}_{s} , {p}_{c} , κ , β ) = A κλ Exp ( π i κ q ) sin c ( π κ q ) \\ A κ λ Exp ( π i κ {p}_{s β} / cos β ) sin c ( π κ {p}_{s β} / cos β )\end{matrix} \\ and & ( 22 ) \\ \begin{matrix}{I}_{F} ( {p}_{s} , {p}_{c} , d , β ) = {( Ad )}^{2} sin {c}^{2} ( kdq / 2 ) \\ = {( A κλ )}^{2} sin {c}^{2} ( π κ {p}_{s β} / cos β )\end{matrix} \\ \begin{matrix}{I}_{F} ( {p}_{s} , {p}_{c} , κ , β ) = {( A κλ )}^{2} sin {c}^{2} ( πκ q ) \\ = {( A κλ )}^{2} sin {c}^{2} ( πκ ( {p}_{s} - {p}_{c} tan β ) )\end{matrix} & ( 23 )\end{matrix}$$

Here, sin cx=sin x/x is the diffraction amplitude of the single slit. It has its maximum where the argument x=0 and at all other zeros of the counter, x=πm_{F},m_{F}∈Z†{0}, there is a zero. This means that for

$${p}_{s β} = 0 ⇔ {n}^{′} sin ( {ϕ}^{′} - β ) - n sin ( ϕ - β ) = 0 \qquad ( 24 )$$

the maximum is to be expected, i.e. in the direction in which refraction would also take place classically, i.e. without the wave nature of light. The zeros lie for m_{F}≠0, in alternative notations, at

$$\frac{k d {p}_{s β} / cos β}{2} = π {m}_{F} \\ {p}_{s β} = cos β \frac{{m}_{F} λ}{d} \\ {n}^{′} sin ( {φ}^{′} - β ) - n sin ( φ - β ) = cos β \frac{{m}_{F} λ}{d} \\ {p}_{s} - {p}_{c} tan β = \frac{{m}_{F}}{κ} \qquad ( 25 )$$

For practical reasons (in favour of a normalised representation of diffraction factor, form factor and total intensity), normalised functions are introduced for the diffraction factor and the form factor, which have the value 1 at the central maximum:

$$\begin{matrix}{I}_{D 0} ( {p}_{x} , N , d ) = \frac{1}{{N}^{2}} {I}_{D} ( {p}_{s} , N , d ) = {( \frac{sin ( {Nkdp}_{s} / 2 )}{sin ( {kdp}_{s} / 2 )} )}^{2} \\ {I}_{D 0} ( {p}_{s} , N , κ ) = \frac{1}{{N}^{2}} {I}_{D} ( {p}_{s} , N , κ ) = {( \frac{sin ( N πκ {p}_{s} )}{N sin ( πκ {p}_{s} )} )}^{2} & ( 26 ) \\ {I}_{F 0} ( {p}_{s} , {p}_{c} , d , β ) = \frac{1}{{( Ad )}^{2}} {I}_{F} ( {p}_{s} , {p}_{c} , d , β ) = sin {c}^{2} ( kdq / 2 ) \\ {I}_{F 0} ( {p}_{s} , {p}_{c} , κ , β ) = \frac{1}{{( A κλ )}^{2}} {I}_{F} ( {p}_{s} , {p}_{c} , κ , β ) = sin {c}^{2} ( πκ q ) & ( 27 ) \\ I = {I}_{D} {I}_{F} \\ {I}_{D} = {I}_{D 0} {I}_{F 0} & ( 28 )\end{matrix}$$

FIG. 3 illustrates a complex or combined grating and represents a variant with different substructures. For its mathematical description, the period of the length d can be subdivided on the basis of the arrow height representation in Eq. (18) according to

$$d = {d}_{1} + {d}_{2} ⇒ {d}_{2} = {d}_{2} ( d , {d}_{1} ) \qquad ( 29 )$$

wherein preferably in the portion d₁ is divided into M₁ grating lines with a blaze angle β₁, the portion d₂ on the other hand is divided into M₂ grating lines with a blaze angle β₂. Here,

$${δ}_{1} ( {d}_{1} , {M}_{1} ) = {d}_{1} / {M}_{1} \\ {δ}_{2} ( {d}_{2} , {M}_{2} ) = {d}_{2} / {M}_{2} \qquad ( 30 )$$

The arrow height in the portion d₁ is then described by

$${z}_{D} ( x ) = \{ \begin{matrix}- x tan {β}_{1} , & 0 \leq x \leq {δ}_{1} \\ - ( x - {δ}_{1} ) tan {β}_{1} , & {δ}_{1} \leq x \leq 2 {δ}_{1} \\ - ( x - 2 {δ}_{1} ) tan {β}_{1} & 2 {δ}_{1} \leq x \leq 3 {δ}_{1} \\ ⋮ & ⋮ \\ - ( x - ( {M}_{1} - 1 ) {δ}_{1} ) tan {β}_{1} & ( {M}_{1} - 1 ) {δ}_{1} \leq x \leq {M}_{1} {δ}_{1}\end{matrix} \qquad ( 31 )$$

and in the portion d₂ by

$${z}_{D} ( x + {d}_{1} ) = \{ \begin{matrix}- x tan {β}_{2} , & 0 \leq x \leq {δ}_{2} \\ - ( x - {δ}_{2} ) tan {β}_{2} , & {δ}_{2} \leq x \leq 2 {δ}_{2} \\ - ( x - 2 {δ}_{2} ) tan {β}_{2} & 2 {δ}_{2} \leq x \leq 3 {δ}_{2} \\ ⋮ & ⋮ \\ - ( x - ( {M}_{2} - 1 ) {δ}_{2} tan {β}_{2} & ( {M}_{2} - 1 ) {δ}_{2} \leq x \leq {M}_{2} {δ}_{2}\end{matrix} \qquad ( 32 )$$

The total intensity is then still described by Eq. (12), but the form factor can be described, instead of by the amplitude from Eq. (22), by the sum of both portions

$${U}_{F} ( {p}_{s} , {p}_{c} , {d}_{1} , {d}_{2} , {β}_{1} , {β}_{2} , {M}_{1} , {M}_{2} ) = {\sum }_{h = 1}^{2} {U}_{F}^{( h )} ( {p}_{s} , {p}_{c} , \{ {d}_{l} \} , {β}_{h} , {M}_{h} ) \qquad ( 33 )$$

For the portion dₕ, this results in

$$\begin{matrix}U \text{?} ( p \text{?} , p \text{?} , [ d \text{?} ] , β \text{?} , M \text{?} ) = \begin{matrix}A \sum \text{?} \int \text{?} Exp [ ik ( xp \text{?} + \text{?} ( x ) p \text{?} ) ] dx ; \\ x - {x}_{h} = \overline{x} \text{?} {x}_{h} = {d}_{1} + {d}_{2} + … + {d}_{h - 1}\end{matrix} \\ = \begin{matrix}Exp [ {ikx}_{h} p \text{?} ] A \sum \text{?} \int \text{?} Exp [ ik ( \overline{x} p \text{?} + \\ \begin{matrix}𝓏 \text{?} ( \overline{x} + x \text{?} ) + p \text{?} ) ] d \overline{x} & \overline{x} - ( j - 1 )\end{matrix} δ \text{?} = \tilde{x}\end{matrix}\end{matrix} \qquad ( 34 )$$

$$\text{?} \text{indicates text missing or illegible when filed}$$

With the abbreviations

$${q}_{h} = {p}_{s} - {p}_{c} tan {β}_{h} , h = 1 , 2 \qquad ( 35 )$$

the following is obtained after simplification (wherein the index ‘h’ is omitted from the dummy arguments):

$$\begin{matrix}U \text{?} ( p \text{?} , p \text{?} , δ , β \text{?} , M ) = \begin{matrix}A \sum \text{?} \int \text{?} Exp [ ik ( \overline{x} p \text{?} + \\ 𝓏 \text{?} ( xp \text{?} ) ] dx \overline{x} - ( j - 1 ) \text{?}\end{matrix} \\ = \begin{matrix}A \sum \text{?} \int \text{?} Exp [ ik ( ( x \text{?} + ( j - 1 \text{?} ) p \text{?} + \\ 𝓏 \text{?} ( ( x \text{?} + ( j - 1 ) \text{?} ) + x \text{?} ) p \text{?} ) ] d \text{?}\end{matrix} \\ = \begin{matrix}A \sum \text{?} \int \text{?} Exp [ ik ( ( j - 1 ) \text{?} p \text{?} ) ] Exp [ ik ( xp \text{?} + \\ 𝓏 \text{?} ( x \text{?} + {x}_{h - 1} ) p \text{?} ) ] dx \text{?}\end{matrix} \\ = \begin{matrix}A \sum \text{?} Exp [ ik ( ( j - 1 ) δ p \text{?} ) ] \int Exp [ ik ( \tilde{x} p \text{?} - \\ \tilde{x} p \text{?} tan {β}_{h} ) ] dx \text{?}\end{matrix} \\ = \begin{matrix}A \int Exp [ {ikxq}_{h} \text{?} ] dx \text{?} \sum \text{?} Exp [ ik ( ( j - 1 ) \text{?} p \text{?} ) ] = \\ A \frac{1}{ikq \text{?}} [ Exp [ ikxq \text{?} ] ] \text{?} \frac{1 - Exp [ Mik δ p \text{?} ]}{1 - Exp [ ik δ p \text{?} ]}\end{matrix} \\ = A \frac{1}{{ikq}_{h}} ( Exp [ ik δ q \text{?} ] - 1 ) \frac{1 - Exp [ Mik δ p \text{?} ]}{1 - Exp [ ik δ p \text{?} ]}\end{matrix} \qquad ( 36 )$$

$$and$$

$$( 37 )$$

$$\begin{matrix}U \text{?} ( p \text{?} , p \text{?} , δ , β \text{?} , M ) = \begin{matrix}A δ \frac{Exp [ ikM δ p \text{?} / 2 ]}{Exp [ ik δ p \text{?} / 2 ]} \frac{Exp [ - ikM δ p \text{?} / 2 ] - Exp [ ikM δ p \text{?} / 2 ]}{Exp [ - ik δ p \text{?} / 2 ] - Exp [ ik δ p \text{?} / 2 ]} \\ ( Exp ( ik δ q \text{?} / 2 ) \frac{Exp ( - ik δ q \text{?} / 2 ) - Exp ( - ik δ q \text{?} / 2 )}{ik δ q \text{?} / 2} )\end{matrix} \\ = \begin{matrix}A δ Exp [ ik δ ( M - 1 ) p \text{?} / 2 ] \frac{sin ( kM δ p \text{?} / 2 )}{sin ( k δ p \text{?} / 2 )} \\ ( Exp ( ik δ q \text{?} / 2 ) \frac{Exp ( - ik δ q \text{?} / 2 ) - Exp ( - ik δ q \text{?} / 2 )}{2 i \times k δ q \text{?} / 2} )\end{matrix} \\ = \begin{matrix}A δ Exp [ ik δ ( ( M - 1 ) p \text{?} + \\ q \text{?} ) / 2 ] \frac{sin ( kM δ p \text{?} / 2 )}{sin ( k δ p \text{?} / 2 )} \frac{sin ( k δ q \text{?} / 2 )}{k δ q \text{?} / 2}\end{matrix} \\ = \begin{matrix}A δ Exp [ ik δ ( ( M - 1 ) p \text{?} + \\ q \text{?} ) / 2 ] \frac{sin ( kM δ p \text{?} / 2 )}{sin ( k δ p \text{?} / 2 )} sin \text{?} ( k δ q \text{?} / 2 )\end{matrix}\end{matrix}$$

$$\text{?} \text{indicates text missing or illegible when filed}$$

28-009520.00025 If, as in Eq. (13), the following abbreviation is used

$$k δ = \frac{2 π}{λ} δ := 2 {πκ}_{δ} \qquad ( 38 )$$

$$then$$

$$\begin{matrix}U \text{?} ( p \text{?} , p \text{?} , δ , β \text{?} , M ) = \begin{matrix}A δ Exp [ i π \text{?} ( ( M - 1 ) p \text{?} + \\ q \text{?} ) ] \frac{sin ( M π \text{?} p \text{?} )}{sin ( π \text{?} p \text{?} )} \frac{sin ( π \text{?} q \text{?} )}{π \text{?} q \text{?}}\end{matrix} \\ = \begin{matrix}A δ Exp [ i π \text{?} ( ( M - 1 ) p \text{?} + \\ q \text{?} ) ] \frac{sin ( M π \text{?} p \text{?} )}{sin ( π \text{?} p \text{?} )} sin \text{?} ( π \text{?} q \text{?} )\end{matrix}\end{matrix} \qquad ( 39 )$$

$$\text{?} \text{indicates text missing or illegible when filed}$$

and in total according to Eq. (33)

$$\begin{matrix}U \text{?} ( p \text{?} , p \text{?} , {d}_{1} , {d}_{2} , {β}_{1} , {β}_{2} , {M}_{1} , {M}_{2} ) = \begin{matrix}U \text{?} ( p \text{?} , p \text{?} , [ d \text{?} ] , β \text{?} , {M}_{1} ) + \\ U \text{?} ( p \text{?} , p \text{?} , [ {d}_{1} , {d}_{2} ] , β \text{?} , {M}_{2} )\end{matrix} \\ = \begin{matrix}Exp [ {ikx}_{1} p \text{?} ] U \text{?} ( p \text{?} , p \text{?} {δ}_{1} , {β}_{1} , {M}_{1} ) + \\ Exp [ {ikx}_{2} \text{?} p \text{?} ] U \text{?} ( p \text{?} , p \text{?} {δ}_{2} , {β}_{2} , {M}_{2} )\end{matrix} \\ = \begin{matrix}U \text{?} ( p \text{?} , p \text{?} , {δ}_{1} , {β}_{1} , {M}_{1} ) + \\ Exp [ {ikd}_{1} p \text{?} ] U \text{?} ( p \text{?} , p \text{?} {δ}_{2} , {β}_{2} , {M}_{2} )\end{matrix} \\ = A ( \begin{matrix}\begin{matrix}{δ}_{1} Exp [ {ikδ}_{1} ( ( {M}_{1} - 1 ) p \text{?} + q \text{?} ) / 2 ] \\ \frac{sin ( kM δ \text{?} p \text{?} / 2 )}{sin ( k δ \text{?} p \text{?} / 2 )} sin \text{?} ( k δ \text{?} q \text{?} / 2 ) +\end{matrix} \\ \begin{matrix}Exp [ {ikd}_{1} p \text{?} ] {δ}_{2} Exp [ ik {δ}_{2} ( ( {M}_{2} - 1 ) p \text{?} + \\ q \text{?} ) / 2 ] \frac{sin ( k M \text{?} δ \text{?} p \text{?} / 2 )}{sin ( k δ \text{?} p \text{?} / 2 )} sin \text{?} ( k {δ}_{2} {q}_{2} / 2 )\end{matrix}\end{matrix} \\ = : Ad ( {Λ}_{1} Exp [ \text{?} ] + {Λ}_{2} Exp [ \text{?} ] )\end{matrix} \qquad ( 40 )$$

$$with$$

$${Λ}_{h} = \frac{{δ}_{h}}{d} \frac{sin ( k {M}_{h} {δ}_{h} p \text{?} / 2 )}{sin ( k {δ}_{h} p \text{?} / 2 )} sinc ( k {δ}_{h} {q}_{h} / 2 ) \qquad ( 41 )$$

$${φ}_{h} = \begin{matrix}{kx}_{h} p \text{?} + k {δ}_{h} ( ( {M}_{h} - 1 ) + p \text{?} + q \text{?} ) / 2 , & h = 1 , 2\end{matrix}$$

$$i . e .$$

$${φ}_{1} = k {δ}_{1} ( ( {M}_{1} - 1 ) p \text{?} + q \text{?} ) / 2 \qquad ( 42 )$$

$${φ}_{2} = {kd}_{1} p \text{?} + k {δ}_{2} ( ( {M}_{2} - 1 ) p \text{?} + q \text{?} ) / 2$$

$$\text{?} \text{indicates text missing or illegible when filed}$$

Overall, the intensity of the form factor

$$I \text{?} ( p \text{?} , p \text{?} , {d}_{1} , {d}_{2} , {β}_{1} , {β}_{2} , {M}_{1} , {M}_{2} ) = {\vert U \text{?} \vert}^{2} = {\vert U \text{?} + U \text{?} \vert}^{2} = ( U \text{?} + U \text{?} ) ( U \text{?} + U \text{?} ) \text{?} = {( Ad )}^{2} ( {Λ}_{1}^{2} + {Λ}_{2}^{2} + 2 {Λ}_{1} {Λ}_{2} cos ( {φ}_{2} - {φ}_{1} ) \qquad ( 43 )$$

$$\text{?} \text{indicates text missing or illegible when filed}$$

The normalised form factor intensity is then according to Eq. (27)

$${I}_{F 0} = {{I}_{F} ( Ad )}^{2} = ( {Λ}_{1}^{2} + {Λ}_{2}^{2} + 2 {Λ}_{1} {Λ}_{2} cos ( {φ}_{2} - {φ}_{1} ) ) = : {I}_{F 0}^{( 1 )} + {I}_{F 0}^{( 2 )} + {I}_{F 0}^{( 12 )} \qquad ( 44 )$$

wherein for the intensities of the subgratings the abbreviations

$${I}_{F 0}^{( h )} = {Λ}_{h}^{2} , h = 1 , 2 \qquad ( 45 )$$

and for the interference term the abbreviation

$${I}_{F 0}^{( 12 )} = 2 {Λ}_{1} {Λ}_{2} cos ( {φ}_{2} - {φ}_{1} ) \qquad ( 46 )$$

have been introduced.

The normalised diffraction factor intensity is given by Eq. (26), so that the total normalised intensity is given as

$$( 47 )$$

$$\begin{matrix}I \text{?} ( p \text{?} , p \text{?} , {d}_{1} , {d}_{2} , {β}_{1} , {β}_{2} , {M}_{1} , {M}_{2} , N ) = \begin{matrix}I \text{?} ( p \text{?} , N , d ) \times \\ I \text{?} ( p \text{?} , p \text{?} , {d}_{1} , {d}_{2} , {β}_{1} , {β}_{2} , {M}_{1} , {M}_{2} )\end{matrix} \\ = {( \frac{sin ( Njdp \text{?} / 2 )}{N sin ( kdp \text{?} / 2 )} )}^{2} ( {Λ}_{1}^{2} + {Λ}_{2}^{2} + 2 {Λ}_{1} {Λ}_{2} cos ( {φ}_{2} - {φ}_{1} )\end{matrix}$$

$$\text{?} \text{indicates text missing or illegible when filed}$$

The methodology presented here can be used to design the structure of spectacle lenses with a myopia stopping effect. The specific procedure will be explained using three examples of preferred embodiments. Even if these examples are described separately, the specific measures for the design of the diffractive microstructures can also be combined.

The first example presented is how (in particular neighbouring) diffraction orders of a simple grating can be used specifically for the base effect and the myopia stopping effect. In order to analyse the intensity distribution on different orders, one would have to evaluate the energy content of each diffraction order by integral formation. However, if the peaks of the diffraction factor are sharp enough, then it is sufficient to evaluate the form factor at the position of the respective angle of incidence that belongs to a particular diffraction order.

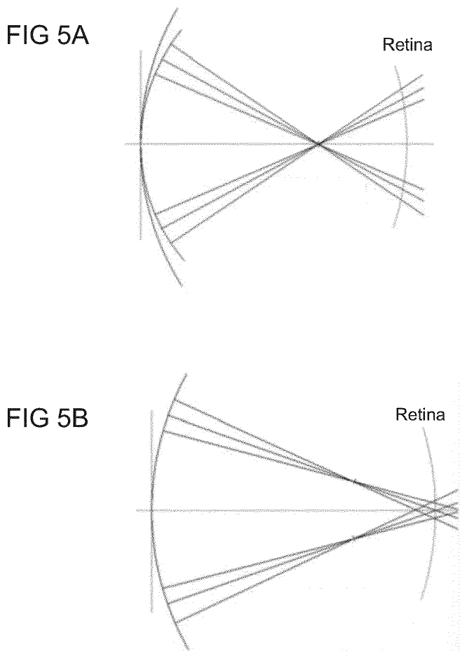

For this purpose, a simple diffraction grating (i.e. without splitting) with a blaze angle of β=3.8° is considered. If the intensity I₀(pₛ,p_{c}, d,0,β,β,1,1,N) for β=3.8° (i.e. tan β=0.0664) is assumed, this gives for the angle of emergence φ′₀=15.09° in the order m=0 an intensity of I₀=0.1564. The corresponding intensity for the angle of emergence φ′₋₁=12.15° in the order m=−1 is I₀=0.6791. The resulting spectrum is shown in FIG. 5. FIG. 5 shows the distributions of diffraction factor I_{D0} (blue), form factor I_{F0} (red), and total intensity I₀ (black) as a function of the angle of incidence φ′ for the blaze angle β=3.8°. In this case, the order m=0 and the order m=−1 are dominant orders, but other orders are also occupied.

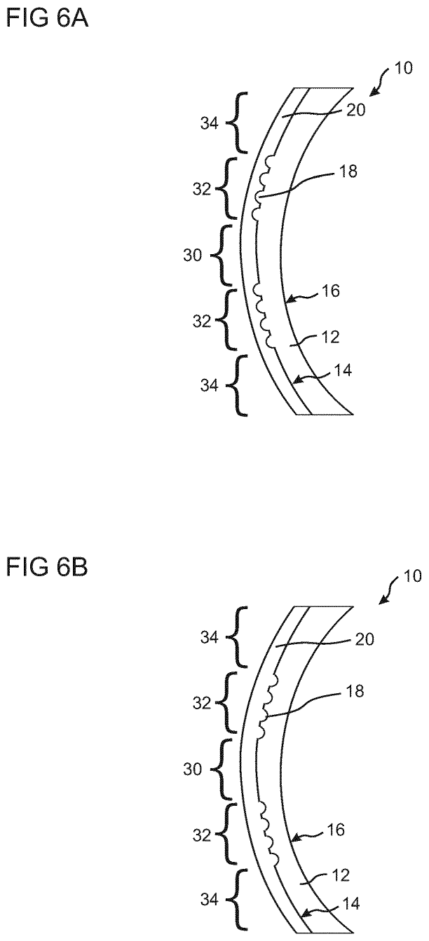

Through a suitable variation of the blaze angle β the intensity can be divided between different diffraction orders. The dependence of the intensity in the two orders m=0 and m=−1 on the blaze angle is shown in FIG. 6. FIG. 6 shows a curve of the intensity in the orders m=0 (blue) and m=−1 (orange) and in the sum of the remaining orders (green) as a function of the blaze angle β. The blaze angle of 3.8° shown corresponds to the situation in FIG. 5. For β≈2.85° (i.e. tan β≈0.0497), both orders m=0 and m=−1 are allotted the same proportion of I₀=0.3956 and a remainder of a good 20% is allotted to the other orders.

This variation of the blaze angle corresponds clearly to the variation of the jump height between the integer multiple of the design wavelength divided by the difference in the refractive indices of the media and the next higher integer multiple of the design wavelength divided by the difference in the refractive indices of the media. This means that the embodiments of using neighbouring diffraction orders for the base effect and the myopia stopping effect described above can be implemented and optimised very well in a targeted manner.

In a second example, it is explained in greater detail how the diffractive microstructures can be constructed using substructures with different effects. In order to obtain an additional degree of freedom compared to simple gratings, the two desired effects (base effect and myopia stopping effect) can be provided by different subgratings (substructures). In the simplest case, the two effects correspond to the m1-th and m2-th diffraction order of a grating with the grating constant (δ).

Further flexibilisation is thus achieved by using two substructures instead of a single periodic structure with a grating parameter A, namely a first substructure with the respective grating parameter A_{G} and a second substructure with the grating parameter A_{M}. Preferably starting from the centre and preferably beginning with the first structure, these alternate outwards in ring-shaped zones. Z_{G}(j) prongs (number of first grating periods) of the first substructure are followed by Z_{M}(j) prongs (number of second grating periods) of the second substructure and then Z_{G}(j+1) prongs of the first substructure and so on. The parameter j is a consecutive variable for numbering the individual zones (or substructures of the same type of substructure, namely the first or second).

The grating parameters A_{G} and A_{M} and diffraction order m_{G} and m_{M} are selected in such a way that the desired effects S_{diff,G} and S_{diff,M} are achieved. In each case, “G” stands for base effect and “M” for myopia stopping effect. The prong numbers Z_{G}(j) and Z_{M}(j) (i.e. the respective number of grating periods) can be used to control the intensity distribution between the two effects. This is described in greater detail below. The number of teeth Z_{G}(j) or Z_{M}(j) can vary with j over the spectacle lens surface.

Dividing the structure into zones or substructures can lead to interference between neighbouring zones of different substructure types and/or interference between successive zones of the same substructure type. These effects must be taken into account when designing the structure.

Interference between neighbouring zones of different substructures can, for example, lead to intensities in undesirable (secondary) orders. This effect can be reduced by increasing the Z, as wider zones reduce the interference between neighbouring zones. Furthermore, this effect can be minimised by suitably matching the A_{G} or A_{M} and the Z_{G}(j) or Z_{M}(j) to each other.

FIG. 7A to 7D compare different arrangements of diffractive microstructures. FIG. 7A shows a periodic grating with only one (locally constant) grating period. FIGS. 7B to 7D schematically illustrate diffractive microstructures, each with two substructures. The two substructures can be distinguished in the schematic representation by different hatching and otherwise differ technically, in particular by a different grating constant or grating period. Thus, in FIGS. 7B to 7D, a first substructure (vertically striped) is uninterrupted by a second substructure (horizontally striped). In the details from FIG. 7B to FIG. 7D, two separate zones are shown for the first substructure, which are separated from each other by a zone of the second substructure.

Interference between successive zones of the same type of substructure is unproblematic for a substructure if the number of prongs is chosen so that the (j+1)-th zone of this type of substructure runs in relation to the j-th zone after the interruption by the other substructure (horizontally striped prongs in FIGS. 7B, 7C and 7D) as if it had not been interrupted by the other substructure (vertically striped prongs in FIGS. 7A and 7D). In this case, constructive interference occurs between the two consecutive zones of one substructure type.

This can be achieved by ensuring that the sum of the widths of the individual prongs of the interrupting other substructure corresponds to the sum of the widths of the individual prongs of the displaced one substructure. (FIG. 7C). However, this is associated with a corresponding restriction of the effects of the two substructures.

This restriction can be avoided if the phase of the interrupted one substructure in the j+1 zone is selected in such a way that it corresponds to the phase position in the uninterrupted case (FIG. 7A).

If this condition is not met (FIG. 7C), destructive or not completely constructive interference may occur between the two consecutive zones of one substructure (i.e. substructure type) in a direction in which constructive interference would be necessary, and at least partial constructive interference may occur in directions in which (as complete as possible) destructive interference is desired. This can reduce the intensity in the desired effect and diffraction intensity in undesired effects or directions.

As in the case of interference between neighbouring zones of different substructures, this effect can be reduced by choosing higher Zs, as wider zones reduce the interference between different zones.

Irrespective of this, higher Zs allow finer control of the intensity distribution with approximately the same ratio. Conversely, Zs that are too high can lead to individually perceptible regions. This may be desirable if, for example, only the base effect is to be provided in a central region. However, if the base effect and myopia stopping effect are to be present within a region, this may be undesirable. The decisive factor here is the region on the lens through which light passes through the pupil when the eye is deflected accordingly. To avoid this, at least one zone of each type of substructure can be located within a region surrounding a view point, which corresponds to a so-called effective pupil. The effective pupil can be calculated from the effect of the lens and the size of the physical pupil and is typically between two and eight millimetres.

In the simplest case, the first diffraction order is used for both substructures. This simplifies the analytical view and ensures uniform structures that are as low as possible. However, higher diffraction orders can also be used. The resulting larger structures may be easier to produce with the necessary precision. However, the diffraction order used can also vary between the two substructures and even between the individual zones of the same substructure. This creates additional degrees of freedom in the design of the structures, which can be used to optimise the diffraction behaviour of the overall structure.

For the significance of secondary maxima in the base or myopia stopping effect and the design to reduce colour errors and their significance in the base or myopia stopping effect, the same applies as described for a single structure.

According to the formalism described below, the two desired effects are realised by combining two subgratings (substructures) with, in particular, the same grating constants (δ₁=δ₂=δ) but different step heights (and thus blaze angles). This offers greater flexibility than the example with only one single periodic grating. The latter only allows the use of two neighbouring diffraction orders, whereas any diffraction orders can be combined by varying the blaze angle.

This can be considered based on a supergrating consisting of the two subgratings with the specified properties. As a basis, a grating can be considered that acts in the first diffraction order and is used as the first subgrating (first substructure). The same grating period can be used for the second subgrating (second substructure), but with a step height corresponding to three times the diffraction order.

For M₁=M₂=1, what is obtained for I₀ is a relatively broad distribution of four peaks around the central diffraction order of the individual gratings (see FIG. 8). This behaviour can be understood phenomenologically by the strong interference of the two substructures. Even by way of a moderate increase in the parameters M₁ and M₂, this broadening can be narrowed, as simulation calculations with M₁=M₂=2 (FIG. 9A), M₁=M₂=5 (FIG. 9B), M₁=M₂=10 (FIG. 9C) and M₁=M₂=50 (FIG. 9D) show. Phenomenologically, this can be understood by the change of the phase offset of the elements of the subgratings relative to each other. A narrow distribution is particularly important for the base effect and at least desirable for the myopia stopping effect. As shown above, this can be achieved by moderately increasing the parameters M₁ and M₂.

Furthermore, a completely different effect can be utilised: In the approximations used in the model presented here, an infinite coherence length is assumed. In reality, however, we are dealing with light of limited coherence length (“in the region of the average wavelength (order of magnitude 10-6 m)”). This means that interference only occurs between reasonably neighbouring grating elements. This effect leads, with the selection of higher parameters M₁ and M₂, to the suppression of parasitic interference between the elements of different subgratings in comparison to the interference within the respective subgratings. The area of the spectacle lens occupied by a light beam that passes through the pupil of the eye and contributes to the imaging on the retina can be selected large enough against the grating constant to achieve correspondingly large Ms (synonymous with M₁ and/or M₂) without causing irregularities in the visual impression. Preferred values for M are preferably in the range from 5 to 200, particularly preferably from 10 to 100. Furthermore, M can also be variable over the range. As the grating constant decreases towards the periphery, the M can increase towards the periphery with the same vignetting through the entry pupil of the eye. Further suppression of parasitic interference can be achieved by using higher diffraction orders. This is because the grating elements participating in the diffraction are further reduced for the given coherence length.

As already mentioned, a third example is a grating consisting of two subgratings with different grating constants and adapted blaze angles, as already described schematically with reference to FIG. 7. The structures of the respective zones do not (necessarily) differ in terms of the diffraction order used, but in terms of the grating constants. This allows an even broader choice of effects, as one is no longer dependent on different diffraction orders of the same grating constant for the effect of the two substructures, but can freely select the grating constant according to the desired effect for each zone (substructure).

In the formalism used here, the two desired effects are thus realised by combining two subgratings with the same step heights but different grating constants (and thus blaze angles).

This is again analysed using a supergrating consisting of two subgratings with the specified properties. As a basis, a grating can be considered that acts in the first diffraction order and is used as the first substructure. A grating with four times the grating constant is considered as the second subgrating. Since the intensity of the contribution of each subgrating depends on the area it occupies, for each grating element from the grating with the higher grating constant, a corresponding number of grating elements from the grating with the lower grating constant could be selected in order to obtain the same intensity. However, it is also preferable to deviate from this in a targeted manner if a different (in particular a locally different) intensity distribution is to be achieved.

Here, for M₁=1 and M₂=4 for I₀, a relatively broad distribution of five peaks around the central diffraction order of the individual gratings is also obtained. Again, this broadening can be narrowed by moderately increasing the Ms, as shown by simulations with M₁=2, 5 and 10 (and M₂=4M₁). For the phenomenological understanding, the application for the construction of a supergrating with two narrow intensity distributions and the utilisation of the limited coherence length of natural radiation, the same that has already been described in relation to the second example applies analogously.

In a spectacle lens, in contrast to a prism, the grating “constant” is preferably not constant over the entire lens, but slowly variable. Particularly in the case of a lens, the prior art discloses a dependency according to d(r)˜1/r, wherein r is the distance from the centre of the lens (see e.g. US 2013/0235337 A1). Such a decrease in the grating period towards the edge is also illustrated schematically in FIG. 1A to 1D. Since, as a good approximation, the step heights of the grating prongs can also be selected to be constant for a spectacle lens, and since the blaze angle is given by tan β=h/d(r), the increase in the steepness of the grating prongs for increasing radius corresponds to tan β˜r.

In particular, the method presented here can be used to simulate the effect of a supergrating consisting of two subgratings in the approximation of Fraunhofer diffraction and infinitely long coherence length. Three different grating concepts were investigated as examples. The results show the occurrence of undesirable interference between the subgratings for the application. These lead to a broadening of the actual desired sharp diffraction orders. In reality, however, these can be sufficiently narrowed by increasing the grating factors M. In addition, these parasitic interferences can be suppressed by the transition to higher Ms and/or higher diffraction orders, since in natural radiation the coherence length and thus the ability to interfere over more distant grating elements (lateral and axial) is limited.

Even if the investigation was carried out for gratings with prismatic effects and constant grating constants, the results and the design principles can be transferred to other gratings according to the invention with dioptric effects and defined variation of the grating constants.

The invention is not limited to the structures described analytically above. Further possibilities include holographic structures in which the structure is determined or manufactured as a holographic structure based on the desired light distribution at a given irradiation.

The intensity distribution between the base effect and the myopia stopping effect can be constant over the entire glass or variable depending on the respective location on the glass. This allows, for example, zones with only the base effect, zones with both effects, and zones with only the myopia stopping effect to be formed. The zones can be ring-shaped, full-sector-shaped or ring-sector-shaped, for example. One advantage of this invention is that it is not only possible to distinguish between a region with the base effect and a region with a myopia stopping effect, but that a continuous transition can be formed.

A simple grating with a single diffraction order can only provide one effect. The simplest structure according to the invention would be a simple grating (in particular with an outwardly decreasing grating constant and) with a step height dependent on the radius, which controls the effect distribution between the base effect (0th diffraction order) and the myopia stopping effect (1st diffraction order).

A simple exemplary embodiment for a myopia stop glass could look like this: A diffractive grating applied to a lens and having a grating constant d(r)=A/r, wherein r is the distance from the centre of the glass, has an optical power of −mλ/A at the wavelength λ and in the diffraction order m. The jump height is h=mλ/(n−1) if the intensity is to land in the m-th diffraction order. If it is desired to create a myopia stop glass that has no additional diffractive effect in the centre of the glass but in the order m=1 on the outside, then the jump height can have a transition between h=0 and h=λ/(n−1).

If the myopia stopping effect at the wavelength λ=550 nm is to be approximately ΔS=2.3 dpt, then a constant A=2.4×10-7 m2 is required. A grating with a constant myopia stopping effect ΔS is shown in FIG. 10A. If a transition is to be installed which has zero effect in the centre, but ΔS in the periphery, then the centre can be damped, as shown in FIG. 10B.

In the following, exemplary details of shapes and dimensions of preferred diffractive microstructures for use in the present invention will be presented. In particular, diffractive microstructures with single periodicity will be discussed first. In these diffractive microstructures, either one diffraction order (complete intensity in one diffraction order) or, for example, two neighbouring diffraction orders can be used.

As shown in the exemplary embodiments of FIG. 1A to FIG. 2D, the diffractive microstructures are preferably rotationally symmetrical about a glass centre, so that a definition of the cross section along a meridian is sufficient.

Preferably at defined intervals r₁, r₂, r₃, . . . in each case one edge follows in succession, wherein the rᵢ are preferably measured from the centre of the glass in the vertical plane (i.e. the tangential plane at the centre of the glass) as projections perpendicular to the vertical plane. Preferably, all edges have substantially the same step height, at least locally h. Preferably, this is also measured perpendicular to the vertical plane. However, it can also be measured perpendicular to the glass surface. The difference is usually only slight and not relevant in this approximation. Preferably, the same curvature k_{G} is present everywhere on the edge-free portions of the diffractive microstructures (i.e. between the edges). This means that the edges in the cross section shown preferably form a grating with a radially variable grating constant d. In particular dᵢ=rᵢ₊₁−rᵢ or dᵢ=rᵢ−rᵢ₋₁. The grating constant d can be particularly preferably defined as a function d(r) of r (so that in the discrete case the variable dᵢ which is actually a function of i can particularly preferably also be written as a function of rᵢ). Preferably, the function d(r) is a Laurent series.

In a preferred embodiment, the grating spacings, i.e. the distances between the edges, are given by d(r)=A/r, and thus

$${d}_{i} = d ( {r}_{i} ) = A / {r}_{i} \qquad ( A 1 )$$

In another preferred embodiment, radii rᵢ are given directly by

$${r}_{i} = \sqrt{aA \cdot ( i - 1 )} \qquad ( A 2 )$$

Eq. (A2) is derived from Eq. (A1) by taking i as a real variable and interpreting Eq. (A1) itself as a differential equation. Its solution is then Eq. (A2). For large values of i it gives the same curve as Eq. (A1), but for small values, especially for i≤10 deviates noticeably from it. Eq. (A2) is therefore given here as an independent embodiment.

The dioptric effect of a grating with a grating constant d(r) is given by the fact that the contribution

$${Δφ}_{diff} ( r ) = \frac{m λ}{d ( r )} \qquad ( A 3 )$$

which the diffractive grating contributes to the prismatic deflection angle is understood as a function of r and the effect is defined as the derivative

$${S}_{diff} ( r ) = \frac{d}{d r} Δ {φ}_{diff} ( r ) \qquad ( A 4 )$$

In the preferred embodiment with d(r)=A/r this effect is constant and in the diffraction order m at the wavelength λ is given by equation (A1) with the grating parameter A.

The grating curvature k_{G}, i.e. the curvature of the cross section of the diffractive microstructure along the meridian, is given by

$${k}_{G} = {k}_{1} + {k}_{diff} \qquad ( A5 )$$

wherein k₁ is the curvature of the base curve and k_{diff} is the diffractive curvature change that is added due to the diffractive grating. The curvature k_{diff} is then preferably matched to the effect, i.e.

$$( {n}_{S} - {n}_{K} ) {k}_{diff} = {S}_{diff} \qquad ( A6 )$$

wherein n_{K} is the refractive index of the main body and n_{S} is the refractive index of the outer material or the cover layer.

The jump height h for the diffractive microstructures, the maximum diffraction intensity of which at the design wavelength λ_{D} is matched to the diffraction order m_{Max} is given by

$$h = \frac{{λ}_{D}}{{n}_{K} cos {φ}_{K} - {n}_{S} cos {φ}_{S}} \cdot {m}_{Max} \approx \frac{{λ}_{D}}{{n}_{K} - {n}_{S}} \cdot {m}_{Max} \qquad ( A7 )$$

wherein φ_{K} is the angle of the beam within the body and φ_{S} is the angle in the cover layer, and the second subexpression without cos terms corresponds to the small-angle approximation at approximately perpendicular incidence

If, on the other hand, the proportion p_{G} is to be diffracted into the order of the base effect m_{G} and as much of the remaining proportion as possible to the order of the myopia stopping effect m_{M}=m_{G}±1, the jump height is calculated as follows

$$h = \frac{{λ}_{D}}{{n}_{K} cos {φ}_{K} - {n}_{S} cos {φ}_{S}} \cdot ( {m}_{G} - \frac{x}{π} ) \approx \frac{{λ}_{D}}{{n}_{K} - {n}_{S}} \cdot ( {m}_{G} - \frac{x}{π} ) \qquad ( A8 )$$

wherein x is a number dependent on p_{G}, for which sin c²x=p_{G}. Naturally, with this type of grating, not all of the remaining proportion 1−p_{G} can be diffracted into the order of the myopia stopping effect, because the remaining orders would then generally also have intensity.

If the base effect and the myopia stopping effect should each have the same intensity (just under 40%), the following applies

$$h = \frac{{λ}_{D}}{{n}_{K} cos {φ}_{K} - {n}_{S} cos {φ}_{S}} \cdot \frac{{m}_{G} + {m}_{M}}{2} \approx \frac{{λ}_{D}}{{n}_{K} - {n}_{S}} \cdot \frac{{m}_{G} + {m}_{M}}{2} \qquad ( A9 )$$

In this case, a proportion of around 10% ends up in each of the neighbouring diffraction orders m_{G}−1 and m_{G}+2 or m_{G}−2 and m_{G}+1.

If the grating is not used for colour fringe correction, the values of the radii rᵢ (or the function d(r)), the values of the step height h and the grating curvature k_{g} are independent of the base lens, i.e. in particular of the lens material. If, on the other hand, the grating is to be applied to a base lens of which the effect S_{K} is purely refractive, the grating should be adjusted to a colour fringe correction, then the values of the radii rᵢ or the function d(r), the values of the step height h and the grating curvature k_{g} are preferably defined by
the refractive index n of the material at the design wavelength λ_{D}
the Abbe number v_{d} of the material
the refractive optical power S_{K} of the base glass at the design wavelength λ_{D}
the base curve k₁

In this embodiment (complete colour fringe compensation), the grating parameter A is given by

$$A = \frac{1}{\vert {S}_{K} \vert} \cdot {λ}_{C} - {λ}_{F} \cdot {v}_{d} \qquad ( A10 )$$

wherein the Abbe number according to (the so-called old) definition is given by

$${v}_{d} := \frac{{n}_{d} - 1}{{n}_{F} - {n}_{C}} \qquad ( A11 )$$

wherein n_{d}, n_{F}, n_{C} are the refractive indices at the constant wavelengths

$${λ}_{d} = 5 87.5618 nm \qquad ( A12 )$$

$${λ}_{C} = 656.2 \; 725 nm$$

$${λ}_{F} = 486.1 \; 327 nm$$

The Abbe number, due to

$$( A13 )$$

$${v}_{d} := \frac{{n}_{d} - 1}{{n}_{F} - {n}_{C}} = \frac{{n}_{d} - 1}{( {n}_{F} - {n}_{C} ) / ( {λ}_{F} - {λ}_{C} ) \cdot ( {λ}_{F} - {λ}_{C} )} \approx \frac{n ( {λ}_{d} ) - 1}{{n}^{′} ( {λ}_{d} ) \cdot ( {λ}_{F} - {λ}_{C} )} \approx \frac{n ( {λ}_{D} ) - 1}{{n}^{′} ( {λ}_{D} ) \cdot ( {λ}_{F} - {λ}_{C} )}$$

is approximately linked with the derivative n′(λ_{D}) of the refractive index according to the wavelength.

Since A according to Eq. (A2) depends on the base effect S_{K} the radii are a function rᵢ(S_{K}) of the counting index i and S_{K}. In the case of a refractive base glass, the diffractive change in curvature is determined by:

$${k}_{diff} = \frac{{S}_{K} \cdot {λ}_{D}}{{λ}_{C} - {λ}_{F} \cdot {v}_{d} \cdot ( n - 1 )} \qquad ( A14 )$$

which means that the overall grating curvature is a function k_{G}=k_{G}(k₁, k_{S}) of the base curve and the base effect.

For at least partial compensation of a colour error, the effect can be understood as a function S(λ, m_{G}, Δm) of the wavelength and the two orders m_{G} and Δm, wherein Δm:=m_{M}−m_{G} is defined. If the relative longitudinal colour error FL_{rL} is defined as a derivative of the total effect S, related to the base effect (receptor effect) S_{G} as a derivative

$${FL}_{rL} := \frac{( \partial / \partial λ ) S ( λ , {m}_{G} , Δ m ) {\vert}_{{λ}_{D}}}{{S}_{G}} \qquad ( B1 )$$

according to the wavelength λ, analysed at a specific design wavelength (reference wavelength) λ_{D}, then a linear equation is obtained

$${FL}_{rL} = a σ + b \qquad ( B2 )$$

as a function of the variable σ, wherein

$$σ := \frac{{m}_{FS}}{Δ m} μ , μ := \frac{Δ S}{{S}_{G}} \qquad ( B3 )$$

and wherein the straight line parameters are given by

$$a = \frac{1}{{λ}_{D}} - \frac{{n}^{′} ( {λ}_{D} )}{n ( {λ}_{D} ) - 1} , b = \frac{{n}^{′} ( {λ}_{D} )}{n ( {λ}_{D} ) - 1} \qquad ( B 4 )$$

The longitudinal colour error disappears at the zero point of the linear equation, i.e. for

$${σ}_{0} = - a / b = \frac{{λ}_{D} {n}^{′} ( {λ}_{D} )}{1 - n ( {λ}_{D} ) + {λ}_{D} {n}^{′} ( {λ}_{D} )} \qquad ( B5 )$$

The zero point itself is also a function of n′(λ_{D}) or the Abbe number.

In order to reduce the colour error, so-called MODs (multi-order diffractive structures) can be used—both in the region of the base effect and in the region of the myopia stopping effect. With simple diffractive structures, the diffraction order with the highest intensity is identical for all wavelengths. With MODs, on the other hand, the structure is designed so that different spectral ranges have their diffraction maxima in different orders. This allows the dispersion to be controlled and the colour error to be minimised. The structure can be designed in such a way that no additional colour error is introduced by the diffractive structure. Preferably, the structure can also be designed in such a way that it (additionally) compensates for the colour error of the refractive effect of the base glass and thus leads to an overall minimal colour error. Such structures can also be used in the zones for the base effect and/or the myopia stopping effect.

In general, the diffractive microstructures can be located either on the front surface or the rear surface of the lens. They are preferably located on the front surface. The base effect can then be determined by the shape of the rear surface using conventional technology (grinding shells) or free-form technology.

Particularly in conjunction with a base curve system, the effect of the diffractive microstructures can be a defocus (“sphere”) and the refractive effect of the opposing surface can have an additional defocus component and an astigmatic component (“cylinder”). This means that the rotational symmetry of the front surface can be retained and yet spectacle lenses with a cylindrical base effect can be provided. Of course, a cylindrical effect of the diffractive microstructures is also possible, but this requires a non-rotationally symmetrical structure.

The diffractive microstructures can also be protected by covering them with a material of which the refractive index differs from that of the spectacle lens. This cover layer can be used both during use and during downstream production steps (e.g. mechanical processing of the opposite surface of the lens) and can also be covered by other layers (e.g. hard layer, anti-reflective layer and/or top coat). It can also serve as a hard layer itself.

The diffractive microstructures can be incorporated directly into the lens (e.g. by machining or embossing). Alternatively, a negative of the diffractive microstructures can be introduced into the casting mould (e.g. by machining or embossing) and transferred into the spectacle lens during casting. Alternatively, the structure can also be introduced as a negative into a transfer layer remaining on the subsequent spectacle lens as a protective layer (e.g. by machining, embossing or casting) and the spectacle lens can then be moulded onto this.

Furthermore, one or more casting moulds (with a negative structure) for the spectacle lens can be made by moulding a directly structured master (with positive structure). This can be advantageous for the following reasons: Firstly, moulding is often more cost-effective than direct structuring. Secondly, materials that are well suited for direct structuring (e.g. nickel alloys) are often less suitable for moulding spectacle lens materials or vice versa (e.g. hardened crown glass).

Furthermore, the structuring can be done photolithographically (e.g. with a mask or with direct laser exposure). This applies to the spectacle lens itself, any transfer layer, any casting mould and any master.

The structures can also be realised by locally changing the refractive index of the spectacle lens material inside the spectacle lens.

If the structures are rotationally symmetrical, they can be realised particularly easily using (precision) lathes or other rotating production systems (e.g. lasers).

If the periodicity of the grating is rotationally symmetrical around the centre, but not the structure height, they can also be produced using (precision) lathes or other rotating production systems (e.g. lasers). In this case, however, it is necessary to vary the tool position or the energy with the polar angle.

The following are non-exclusive examples of the materials used:

Materials for spectacle lenses:
Perfalit 1.5 (chemical name: polyethylene glycol bisallyl carbonate, based on CR 39 (Columbia Resin 39) from PPG, refractive index 1.5, Abbe number 58),
PCM 1.54 (chemical name: polyethylene glycol dimethacrylate, refractive index 1.54, Abbe number 43)
Polycarbonate (refractive index 1.59, Abbe number 29)
Perfalit 1.6 (chemical name: polythiourethane, refractive index 1.60, Abbe number 41)
Perfalit 1.67 (chemical name: polythiourethane, refractive index 1.67, Abbe number 32)
Perfalit 1.74 (chemical name: polythiourethane, refractive index 1.74, Abbe number about 32)

Materials for transfer layers:
TS56T (3) from Tokuyama (refractive index of 1.49)
IM-9200 from SDC Technologies (optical power between 1.585 and 1.605)
Transhade from Tokuyama (if necessary with primer (Transhade-SC-P) as adhesion promoter, refractive index 1.54)
Hi Guard 1080 from PPG

Furthermore, the materials mentioned under materials for spectacle lenses can also be used for the transfer layers.

Materials for casting moulds:
Crown glass (for example tempered crown glass type CH-W 0991 (S-3) from Barberini GmbH based on Schott materials)
Quartz glass (“fused silica”)
Metals (e.g. steel, nickel, nickel alloys)
Plastics (e.g. polycarbonate (PC), polyamide (PA), polymethyl methacrylate (PMMA))

Materials for carrier substrates:
The materials listed under materials for spectacle lenses
The materials listed under materials for casting moulds

A preferred material combination is: spectacle lens: Perfalit 1.6 or 1.67, transfer layer: Transshade, casting mould: crown glass CH-W 0991, carrier substrate: Perfalit 1.5

In principle, a wide variety of materials are possible, such as plastics, glass or metals, both individually and in combination. The individual materials can be layered and/or structured on the surface.

1.-16. (canceled)

17. A spectacle lens which has at least one diffractive effect zone as at least a part of a viewing region of the spectacle lens such that the spectacle lens comprises diffractive microstructures in the diffractive effect zone, said microstructures generating at least one base effect in each view point of the diffractive effect zone or a myopia stopping effect which deviates therefrom, wherein the diffractive effect zone comprises a combination zone in which the diffractive microstructures generate a combination of the base effect and the myopia stopping effect simultaneously.

18. The spectacle lens according to claim 17, wherein the myopia stopping effect in each view point of the combination zone has a shorter focal length than the base effect.

19. The spectacle lens according to claim 17, wherein the diffractive microstructures are formed in a ring-shape, in particular rotationally symmetrically, around a centre of the spectacle lens.

20. The spectacle lens according to claim 17, wherein the diffractive microstructures have a sawtooth shape in a cross section.

21. The spectacle lens according to claim 17, wherein the diffractive microstructures have constant step heights.

22. The spectacle lens according to claim 17, wherein the base effect and the myopia stopping effect are each brought about by a corresponding diffraction order of the light diffraction by the diffractive microstructures.

23. The spectacle lens according to claim 17, wherein the base effect and/or the myopia stopping effect is produced as the zeroth diffraction order of the diffractive microstructures.

24. The spectacle lens according to claim 17, wherein the diffractive microstructures for each view point of a plurality of view points within the combination zone have at least substantially a single periodicity, wherein the base effect and the myopia stopping effect are brought about by different diffraction orders of a diffraction grating formed thereby.

25. The spectacle lens according to claim 24, wherein the respective diffraction orders of the base effect and the myopia stopping effect differ from each other by 1.

26. The spectacle lens according to claim 17, wherein the diffractive microstructures comprise, for each view point, a plurality of view points within the combination zone:
a first diffractive substructure, which substantially generates the base effect; and
a second diffractive substructure, which substantially generates the myopia stopping effect.

27. The spectacle lens according to claim 26, wherein the first substructure is formed by a first periodic diffraction grating with a first grating period and a first grating amplitude, and wherein the second substructure is formed by a second periodic diffraction grating with a second grating period and a second grating amplitude.

28. The spectacle lens according to claim 27, wherein the first grating amplitude and the second grating amplitude differ from each other, while preferably the first and the second grating period substantially coincide.

29. The spectacle lens according to claim 27, wherein the first grating period and the second grating period differ from each other, while preferably the first and the second grating amplitude substantially coincide.

30. The spectacle lens according to claim 27, wherein the diffractive microstructures comprise a plurality of first substructures and a plurality of second substructures, in each case arranged alternately with respect to each other.

31. The spectacle lens according to claim 30, wherein along a continuous path within the combination zone a number of the first grating periods of the first substructures and a number of the second grating periods of the second substructures change successively in opposite directions.

32. The spectacle lens according to claim 27, wherein a number of grating periods in each substructure is in the range of about 2 to about 200, preferably in a range of at least about 5, more preferably at least about 10; and/or in a range of not more than about 100.
